(19) United States
(12) Patent Application Publication
(10) Pub. No.: US 2026/0120034 A1
(43) Pub. Date: Apr. 30, 2026

(54) ARTIFICIAL INTELLIGENCE DECISION SUPPORT SYSTEM FOR MANUFACTURING MANAGEMENT

(71) Applicant: Morale AI CO., LTD., Hsinchu City (TW)

(72) Inventors: Sheng-Xiang KAO, Hsinchu City (TW); Chien-Tse CHENG, Hsinchu City (TW)

(73) Assignee: Morale AI CO., LTD., Hsinchu City (TW)

(21) Appl. No.: 19/367,615

(22) Filed: Oct. 23, 2025

Related U.S. Application Data
(60) Provisional application No. 63/711,709, filed on Oct. 25, 2024.

(51) Int. Cl. G06Q 10/0637; G06F 40/205; G06F 40/30; G06F 40/40; G06Q 50/04

(52) U.S. Cl. CPC G06Q 10/0637; G06F 40/205; G06F 40/30; G06F 40/40; G06Q 50/04

(57) ABSTRACT

An artificial intelligence decision support system for manufacturing management is disclosed, which is implemented as a computer system that comprises a data warehouse and a host device, wherein the host device includes a processor and a storage device. In particular, the storage device stores an application program, and the processor executes the application program to perform the following functions: displaying a user operation interface on a display of a client device; converting natural language content and/or unstructured data provided through the user operation interface into a semantic embedding vector; processing the semantic embedding vector to obtain a task objective; activating a corresponding intelligent agent module to perform a retrieval-augmented generation (RAG) operation in the data warehouse based on the task objective to produce RAG data; and activating a large language model to generate a natural language specification and/or a visualization specification according to the RAG data.

### CROSS-REFERENCE TO RELATED APPLICATIONS

This application claims the benefit of U.S. Provisional Application No. 63/711,709, filed on Oct. 25, 2024, the entire disclosure of which is hereby incorporated by reference.

### BACKGROUND OF THE INVENTION

### 1. Field of the Invention

The present invention relates to the technical field of artificial intelligence application systems, and more particularly to an artificial intelligence decision support system for manufacturing management. Specifically, the present invention pertains to a decision support architecture that integrates a large language model (LLM), a Data Warehouse, and multi-agent models to assist the manufacturing industry in production process analysis, equipment maintenance, quality monitoring, and operational decision management.

### 2. Description of the Prior Art

It is known that database systems and various information systems—such as Manufacturing Execution Systems (MES), Enterprise Resource Planning (ERP) systems, and quality and maintenance systems—are indispensable to the manufacturing industry. However, the operation of MES, ERP, or quality and maintenance systems must be performed by personnel with dedicated access privileges. In practice, although R&D engineers or manufacturing management personnel clearly understand the sources of problems and the requirements for analysis (for example, during product anomaly tracing or new process/solution development), they often find it difficult to directly operate the databases to retrieve relevant data such as historical parameters, process records, and quality inspection results. When assistance from authorized personnel is required to conduct such queries, it not only increases communication and waiting costs but also burdens those personnel, who are usually occupied with other daily tasks and thus unable to provide immediate support. This operational mode makes it difficult for R&D engineers or manufacturing management personnel to promptly complete problem source analysis, ultimately resulting in delayed decision-making and reduced response efficiency.

Accordingly, existing technologies have attempted to address the aforementioned problems by utilizing large language models (LLMs) and other artificial intelligence (AI) techniques. Most of these solutions belong to general-purpose AI systems, which may support database queries or automated report generation. However, their operational efficiency is often low, and their accuracy and practicality in analyzing and answering problems specific to manufacturing domains are limited. To enhance their performance within a specific domain, model retraining or fine-tuning is typically required. Nevertheless, such adjustments entail significant costs, making them difficult for enterprises to maintain on a continuous basis.

In practice, there is currently no urgent need for the manufacturing industry to adopt general-purpose large-scale language models. The reason lies in the fact that problems encountered on production lines and in operational environments are typically real-time and domain-specific, requiring not broad language comprehension but rather the ability to quickly provide concrete, actionable solutions. For example:
(1) Maintenance-related information is vast and scattered across multiple systems or documents, making it difficult for maintenance personnel to locate maintenance records, error codes, or troubleshooting procedures.
(2) Although the R&D department has accumulated a large amount of technical data and test reports over time, it is often difficult to rapidly retrieve key information needed to support design decisions during actual operations.
(3) The procurement and supply chain management departments must handle numerous supplier quotations and product specification documents. The process is complex and time-consuming, and when the company relies excessively on a single supplier, it becomes difficult to evaluate alternative solutions to achieve optimal cost efficiency.

Although general-purpose large language models (LLMs) perform well in tasks such as data classification, organization, and prediction, they still face significant limitations in practical manufacturing applications. First, such models lack domain-specific task knowledge and operational logic, often producing vague or incorrect answers—known as hallucinations—when responding to professional or technical questions. Second, general-purpose LLMs typically lack the ability to connect directly with internal and/or external enterprise databases, and they do not include a dedicated data warehouse tailored to specific application scenarios. Because their responses are not grounded on structured reference data, the generated results are difficult to verify or trace. Furthermore, these systems lack a multi-level Retrieval-Augmented Generation (RAG) mechanism, preventing the model from integrating multi-source data or considering domain-oriented task logic when generating answers. As a result, they fail to provide reliable and consistent decision recommendations.

From the foregoing description, it is evident that existing general-purpose large language models or artificial intelligence systems, when applied to factory decision management, data governance, and root cause analysis in the manufacturing industry, exhibit problems such as insufficient efficiency, low accuracy, and a lack of real-time data integration capabilities. Therefore, improvements are clearly needed. Accordingly, the technical problem that the present invention seeks to address is how to establish an artificial intelligence decision support system that integrates a structured reference data warehouse with multi-domain task logic modules, enabling a large language model to generate verifiable responses based on knowledge-grounded contexts. This approach effectively reduces the likelihood of hallucination generation and enhances decision reliability.

### SUMMARY OF THE INVENTION

The primary objective of the present invention is to provide an Artificial Intelligence Decision Support System for Manufacturing Management, which is implemented in the form of a computer system and applied to factory decision management, data governance, and root cause analysis in the manufacturing industry. Compared with existing technical solutions that rely solely on general-purpose large language models, the present invention includes the following distinct technical features:

### (1) Connectivity to Internal Enterprise Databases

The system is capable of connecting to internal databases to instantly access and integrate information covering the entire factory operation process, including but not limited to: production scheduling, equipment operation records, process parameter settings, new solution or process development (parameter design), material traceability, quality inspection results, maintenance and service records, and root cause analysis of customer complaint products.

### (2) Connectivity to External Databases

The system integrates relevant external information sources, including but not limited to: supply chain data (e.g., supplier quotations, product specification documents, logistics and delivery information), market and maintenance feedback data (e.g., customer complaint reports, on-site maintenance records), and industry standards and regulatory compliance data.

### (3) Dedicated Data Warehouse

The system comprises a data warehouse that aggregates and standardizes structured data (such as data tables, sensor data, and process parameter records) and unstructured data (such as PDF documents, reports, images, audio, and email content) from various internal and external systems. This establishes a consistent and retrievable data foundation that supports subsequent operations of domain-oriented task logic modules for semantic retrieval, relational querying, and content integration. The data warehouse serves as the core data source of the entire manufacturing management decision support system.

### (4) Multiple Domain-Oriented Task Logic Modules (Domain-Oriented Task Logic Modules, Also Referred to as LLM AI Agents)

The system includes multiple modules, each preconfigured with specific retrieval strategies, prompt templates, and response formats corresponding to different manufacturing domains (e.g., maintenance management, quality analysis, R&D design, procurement, or production scheduling). Each module can perform a Retrieval-Augmented Generation (RAG) process based on user commands, retrieving relevant content from the data warehouse and assembling corresponding prompt instructions to generate responses provided by the system's LLM to the user.

Accordingly, the present invention provides the following advantages:
(a) Unlike conventional approaches that rely directly on the language generation results of general-purpose LLMs, the present invention ensures that generated content is based on authentic and auditable data sources through the collaborative operation of a dedicated data warehouse and domain-oriented task logic modules. This effectively reduces the risk of erroneous or hallucinatory responses typically produced by general-purpose LLMs.
(b) By establishing real-time connections with internal and external databases, the system can automatically retrieve the latest production, quality, and maintenance data, enabling users to obtain specific and actionable answers to targeted problems rather than merely textual descriptions or generic suggestions.
(c) Each domain-oriented task logic module encapsulates corresponding retrieval strategies and prompt templates, allowing repeated use and continuous optimization according to different application contexts, thereby eliminating the high cost and technical complexity associated with retraining or fine-tuning large models.
(d) The invention enables multi-turn natural language interactions between users and the system, while preserving data citations and retrieval logs in each generated result. This ensures that the decision-making process remains traceable and compliant with factory governance requirements.

To achieve the aforementioned objective, the present invention provides an embodiment of the artificial intelligence decision support system, which is implemented in the form of a computer system, and comprises:
at least one electronic device, comprising a data warehouse, wherein the data warehouse stores a plurality of reference vector data associated with a plurality of structured reference data;
at least one host device, being communicatively connected to the electronic device for accessing the data warehouse, and including a processor and a storage device, wherein the storage device stores an application program comprising a semantic embedding vector generation module, a plurality of domain-oriented task logic modules, and a large language model (LLM) module, and wherein the processor executes the application program and is thereby configured to perform the following operations:
under a condition where a client-end electronic device is communicatively connected to the host device, transmitting a user interface configuration data to the client-end electronic device, such that the client-end electronic device controls a corresponding client-end display to show a user operation interface;
upon the user operation interface being operated to input at least one first user-provided natural language content and/or upload at least one first user-provided unstructured data, activating the semantic embedding vector generation module to convert the first user-provided natural language content and/or the first user-provided unstructured data into a first semantic embedding vector;
activating the large language model module to perform semantic recognition and intent parsing on the first semantic embedding vector, thereby obtaining at least one first task objective;
activating at least one of the domain-oriented task logic modules corresponding to the at least one first task objective, such that each of the domain-oriented task logic modules performs a first domain-oriented decision generation operation, wherein the first domain-oriented decision generation operation includes:
   based on the first semantic embedding vector, retrieving from the data warehouse at least one reference vector data that includes at least one of the structured reference data; and
   based on the first task objective and the retrieved at least one reference vector data that includes at least one of the structured reference data, generating a first retrieval-augmented data and transmitting the same to the large language model module;
activating the large language model module to generate, based on the first retrieval-augmented data, a first natural language specification and/or a first visualization specification; and
transmitting a user interface update data comprising the first natural language specification and/or the first visualization specification to the client-end electronic device, such that the user operation interface displays the first natural language specification and/or the first visualization specification;
wherein the first visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

In one embodiment, the processor is further configured to perform the following operations:
upon the client-end electronic device receiving from a customer-end electronic device at least one customer-provided natural language content and/or at least one customer-provided unstructured data, and upon the user operation interface being operated to input at least one second user-provided natural language content and/or upload the at least one customer-provided unstructured data, activating the semantic embedding vector generation module to convert the second user-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
   based on the second semantic embedding vector, retrieving from the data warehouse at least one reference vector data; and
   based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting second user interface update data comprising the second natural language specification and/or the second visualization specification to the client-end electronic device, such that the user operation interface displays the second natural language specification and/or the second visualization specification;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

In one embodiment, the processor is further configured to perform the following operations:
after receiving from a customer-end electronic device at least one customer-provided natural language content and/or uploading at least one customer-provided unstructured data, activating the semantic embedding vector generation module to convert the customer-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
   based on the second semantic embedding vector, retrieving from the data warehouse at least one reference vector data; and
   based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting a reply feedback data comprising the second natural language specification and/or the second visualization specification to the client-end electronic device, such that the client-end electronic device forwards the reply feedback data to the customer-end electronic device;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

In one embodiment, the processor is further configured to perform the following operations:
receiving from a customer-end electronic device at least one customer-provided natural language content and/or uploading at least one customer-provided unstructured data, activating the semantic embedding vector generation module to convert the customer-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
   based on the second semantic embedding vector, retrieving from the data warehouse at least one reference vector data; and
   based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting a reply feedback data comprising the second natural language specification and/or the second visualization specification to the customer-end electronic device;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

In one embodiment, the customer-end electronic device is configured to provide the customer-provided natural language content and/or the customer-provided unstructured data to the host device through a data transmission channel, wherein the data transmission channel is selected from a group consisting of customer service application, instant messaging application, corporate web platform, and email transmission system.

In one embodiment, each of the client-end electronic device and the customer-end electronic device is selected from a group consisting of desktop computer, laptop computer, tablet computer, all-in-one computer, and smartphone.

In one embodiment, the electronic device is selected from a group consisting of local storage device, cloud storage device, and data center, and further includes a first application program interface (API).

In one embodiment, the host device is selected from a group consisting of AI computing platform, server, cloud computing device, and edge computing device.

In one embodiment, the storage device is selected from the group consisting of a hard disk drive (HDD), a flash memory, and a solid-state drive (SSD).

In one embodiment, the file format of the unstructured data is selected from a group consisting of document file, report file, portable document format (PDF) file, text file, E-mail data file, image file, audio file, video file, event log file, event data file, sensor log file, and configuration file.

In one embodiment, the application program further comprises:
a user interface configuration module; and
a database management module;
wherein, when executing the application program, the processor activates the user interface configuration module to generate the user interface configuration data, and activates the database management module to manage the data warehouse.

In one embodiment, the artificial intelligence decision support system further comprises:
at least one first electronic device, being communicatively connected to the electronic device and the host device, and including a first database that stores a plurality of first structured data; and
at least one second electronic device, being communicatively connected to the electronic device, and including a second database that stores a plurality of second structured data;
wherein each of the first structured data corresponds to internal company data, and each of the second structured data corresponds to external company data;
wherein the first semantic embedding vector includes a first vector portion associated with the first user-provided natural language content and a second vector portion associated with the user-provided unstructured data, and the database management module updates the plurality of first structured data based on the second vector portion, and further configures the first application program interface (API) to update the plurality of structured reference data in the data warehouse according to the updated first structured data;
wherein the second semantic embedding vector includes a third vector portion associated with the customer-provided natural language content and a fourth vector portion associated with the customer-provided unstructured data, and the database management module updates the plurality of first structured data based on the fourth vector portion, and further configures the first application program interface (API) to update the plurality of structured reference data in the data warehouse according to the updated first structured data;
wherein, after the plurality of second structured data are updated, the database management module updates the plurality of structured reference data in the data warehouse according to the updated second structured data.

In one embodiment, the application program further comprises a user account management module, and the processor is further configured to perform the following operations:
upon the user operation interface being operated to perform a user account management action, activating the user account management module to process data generated from the account management action, and to store at least one account data generated from the account management action into an account database, such that the account database stores at least one administrator account data corresponding to at least one administrator account, and a plurality of regular account data respectively corresponding to a plurality of regular accounts;
wherein the account management action is selected from a group consisting of regular account management actions and administrator account management actions;
wherein the regular account management action is selected from a group consisting of registering one of the plurality of regular accounts, logging into the regular account, logging out of the regular account, modifying regular account data, and deleting the regular account;
wherein the administrator account management action is selected from a group consisting of registering the administrator account, logging into the administrator account, logging out of the administrator account, modifying administrator account data, creating a user group consisting of at least one of the plurality of regular accounts, assigning access permissions to at least one of the plurality of regular accounts, reviewing operation logs, and disabling at least one of the plurality of regular accounts.

In one embodiment, the processor is further configured to perform the following operations:
controlling the activation or deactivation of the plurality of domain-oriented task logic modules according to the permission level of the regular account or the administrator account;
upon performing a regular account management action to log into the regular account, activating at least one of the domain-oriented task logic modules corresponding to the permission level of the regular account, and deactivating the remaining domain-oriented task logic modules; and
   upon performing an administrator account management action to log into the administrator account, activating all of the domain-oriented task logic modules according to the permission level of the administrator account.

In one embodiment, the processor is further configured to perform the following operations:
when the user operation interface is not operated to select a specific one of the domain-oriented task logic modules, activating the large language model module to perform semantic recognition and intent parsing on the first semantic embedding vector, and selecting, based on the results of the semantic recognition and intent parsing, at least one corresponding domain-oriented task logic module to perform the first domain-oriented decision generation operation; and
when the user operation interface is operated to select a specific one of the domain-oriented task logic modules, directly selecting the specified domain-oriented task logic module to perform the first domain-oriented decision generation operation.

### BRIEF DESCRIPTION OF THE DRAWINGS

FIG. 1 is a block diagram of an artificial intelligence decision support system according to one embodiment of the present invention;

FIG. 2 is a block diagram of the host device shown in FIG. 1;

FIG. 3A is a first schematic diagram of a user operation interface displayed on a client-end display of the client-end electronic device shown in FIG. 1;

FIG. 3B is a second schematic diagram of a user operation interface displayed on the client-end display of the client-end electronic device shown in FIG. 1; and

FIG. 3C is a third schematic diagram of a user operation interface displayed on the client-end display of the client-end electronic device shown in FIG. 1.

### DETAILED DESCRIPTION OF THE PREFERRED EMBODIMENTS

To more clearly describe an artificial intelligence decision support system for manufacturing management according to the present invention, embodiments of the artificial intelligence decision support system will be described in detail with reference to the attached drawings hereinafter.

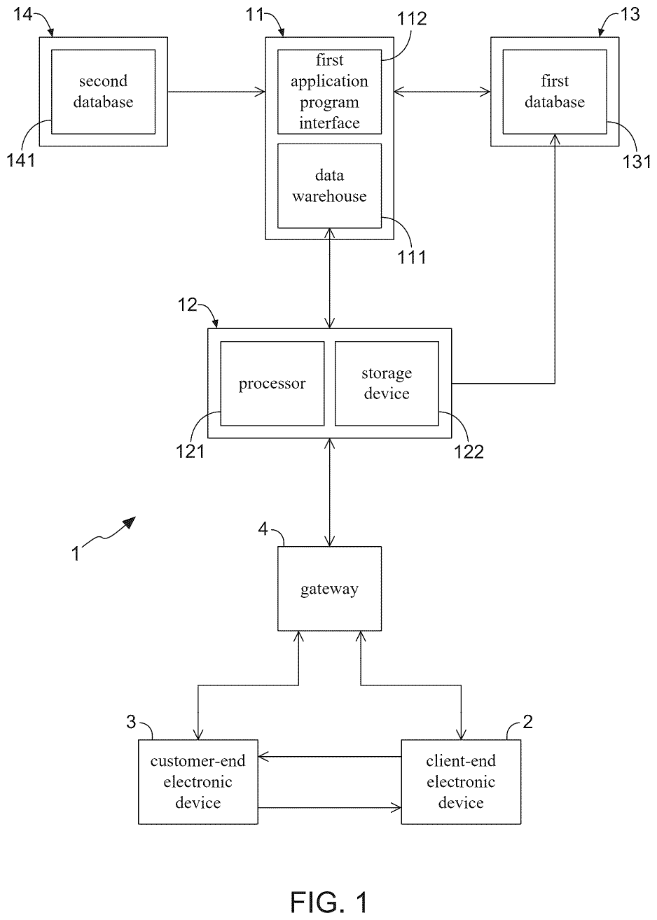

The present invention provides an artificial intelligence decision support system for manufacturing management, which is implemented in the form of a computer system and applied to factory decision management, data governance, and root cause analysis in the manufacturing industry. FIG. 1 illustrates a block diagram of one embodiment of the artificial intelligence decision support system 1. As shown in FIG. 1, the system 1 mainly comprises at least one electronic device 11 and at least one host device 12, wherein the electronic device 11 may be, but is not limited to, an industrial-grade local storage device, cloud storage device, or data center, and includes a data warehouse 111 and a first application program interface (API) 112. Specifically, the electronic device 11 further includes a second application program interface configured to access and manage the data warehouse 111 through the second application program interface, such that the data warehouse 111 stores a plurality of reference vector data.

In one embodiment, during the initial implementation phase (phase 1), the system provider performs data governance. Specifically, in the data governance stage, the system provider conducts multiple interviews with a specific user (for example, a textile factory) to understand the user's actual operational processes and pain points related to factory decision management, data governance, and root cause analysis. Based on these interviews, relevant data are collected, including internal data (i.e., the structured data stored in the first database 131 shown in FIG. 1) and unstructured documents such as management documents, R&D reports, machine operation manuals, maintenance records, and troubleshooting SOPs. Subsequently, these structured and unstructured data are converted into corresponding reference vector data and stored in the data warehouse 111. For example, the structured data may include process parameter records, which typically contain multiple fields such as production batch number, process temperature, pressure, speed, test items, inspection results, and abnormality indicators, and are usually stored in structured formats such as .sql, .csv, or .xlsx files within the enterprise's internal database (i.e., the first database 131). As another example, the unstructured data may include R&D reports or standard operating procedure (SOP) documents, typically stored as .pdf, .docx, or scanned image files on the computers of authorized personnel in relevant departments.

In other words, the unstructured data include, but are not limited to, a document file, report file, portable document format (PDF) file, text file, e-mail data file, image file, audio file, video file, event log file, event data file, sensor log file, and configuration file. It is easily understood that the system provider, through document parsing and natural language processing (NLP) techniques, performs semantic segmentation and encoding on the structured data and/or unstructured data, and then converts them into vector forms using an embedding model. Finally, the converted data are stored in the data warehouse 111 in formats such as .md, .json, .npy, or .parquet, such that the data warehouse 111 stores a plurality of reference vector data.

In addition, during the data governance stage, the system provider may, according to the authorization and business requirements of a specific user, integrate external data sources related to the user's supply chain system. Specifically, the external data are provided by the customer and obtained from databases maintained by external entities such as suppliers, partners, industry associations, or trade organizations (i.e., the second database 141 shown in FIG. 1). The system provider then performs document parsing and natural language processing (NLP) techniques on the external data, which include structured data and/or unstructured data, to conduct semantic segmentation and encoding, and converts the processed data into vector forms using an embedding model. The resulting data are finally stored in the data warehouse 111 in formats such as .md, .json, .npy, or .parquet, such that the data warehouse 111 stores a plurality of reference vector data. For example, the external data may include documents such as supplier raw material batch information, inspection reports, shipping and receiving records, energy consumption records, industry quality standards, or industry knowledge base documents.

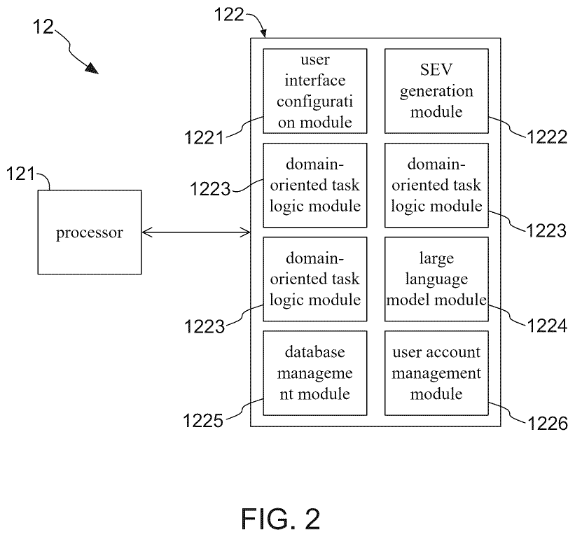

Furthermore, FIG. 2 is a block diagram of the host device 12 shown in FIG. 1. As illustrated in FIGS. 1 and 2, the host device 12 is communicatively connected to the electronic device 11 to access and manage the data warehouse 111, and includes a processor 121 and a storage device 122. In a feasible embodiment, the host device 12 may be, but is not limited to, an AI computing platform, a server, a cloud computing device, or an edge computing device, such as the NeMo platform sold by Nvidia. On the other hand, the storage device 122 may be, but is not limited to, a hard disk drive (HDD), a solid-state drive (SSD), or a flash memory.

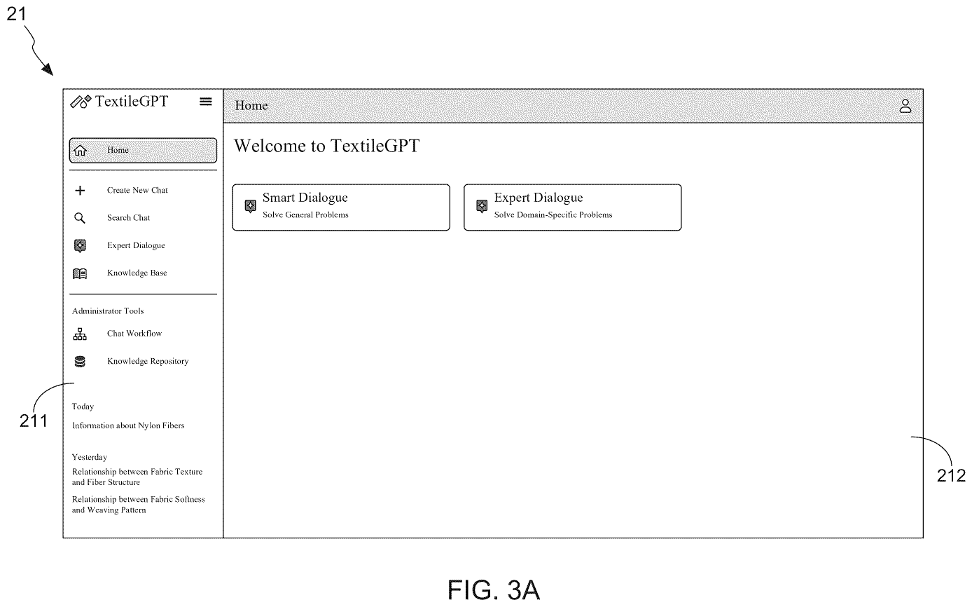

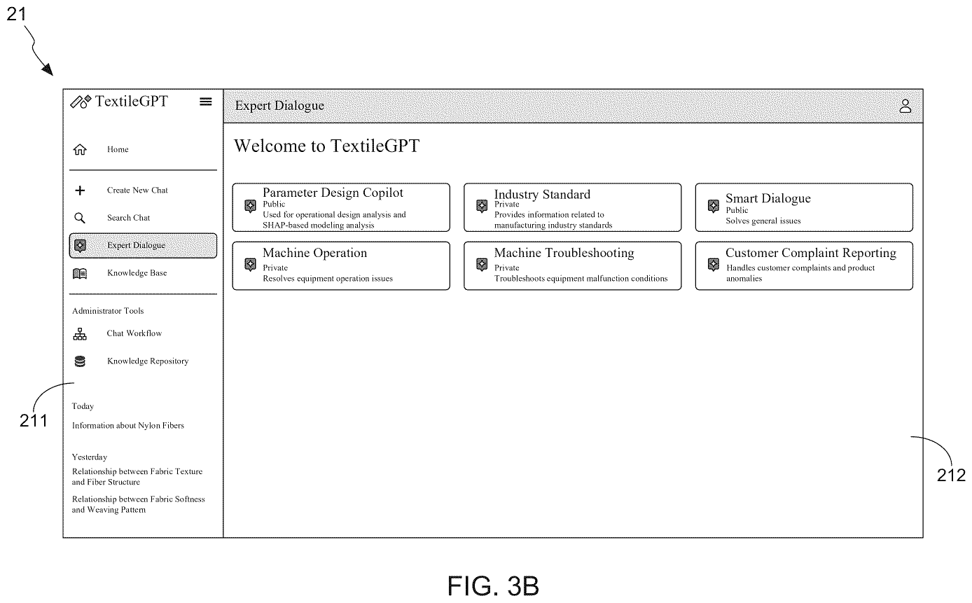

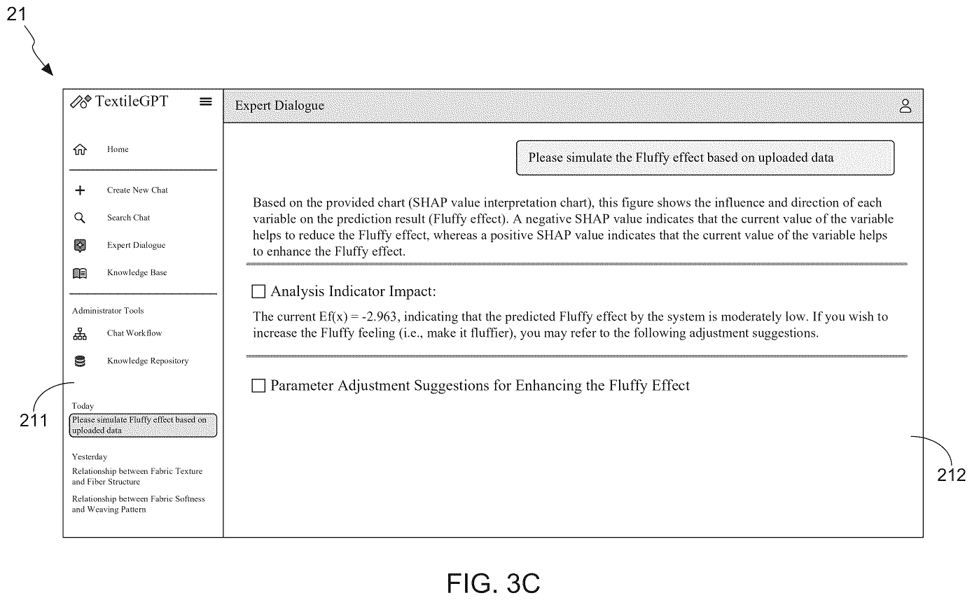

Specifically, the storage device 122 stores an application program, which includes a user interface configuration module 1221, a semantic embedding vector (SEV) generation module 1222, a plurality of domain-oriented task logic modules 1223, a large language model module 1224, a database management module 1225, and a user account management module 1226. The processor 121, upon executing the application program, is thereby configured to perform various functions. It should be noted that FIG. 2 schematically illustrates only two domain-oriented task logic modules 1223 to conceptually represent that the module may serve as an abstract structure for multiple independent domain-specific AI agents. In practical implementation, as shown in FIG. 3B, the system may include multiple domain-oriented task logic modules 1223, such as “Parameter Design Copilot,” “Industry Standards,” “Machine Operation,” “Machine Troubleshooting,” and “Customer Complaint and Anomaly Reporting.” Each of these modules is capable of performing corresponding decision generation logic and retrieval-augmented operations based on different task objectives and semantic vector data, thereby supporting various manufacturing management decision-making scenarios.

Specifically, when a client-end electronic device 2 is communicatively connected to the host device 12, the processor 121 is configured to transmit user interface configuration data to the client-end electronic device 2, such that the client-end electronic device 2 controls a corresponding client-end display to present a user operation interface 21. FIGS. 3A, 3B, and 3C respectively illustrate first, second, and third schematic diagrams of the user operation interface 21 displayed on the client-end display of the client-end electronic device shown in FIG. 1. As shown in FIG. 3A, the user operation interface 21 is similar to the user interfaces of existing large language models (e.g., ChatGPT, Gemini) and mainly includes a left navigation bar section 211 and a central display section 212. More specifically, the left navigation bar section 211 is used to display multiple functional menu items, such as Home, New Chat, Search Chat, Expert Dialogue, and Knowledge Base. In addition, the left navigation bar section 211 also displays an Administrator Function option and historical conversation topics.

As described above, the central display section 212 is used to present the main operation screen after the user logs in. The display section includes a title area showing the text “Welcome to TextileGPT”, and below it provides two interactive buttons: “Smart Dialogue” and “Expert Dialogue.” The user may select either button to initiate different levels or domain-oriented AI agent dialogue modes. In this way, the user can operate the client-end electronic device 2 to input at least one first user-provided natural language content and/or upload at least one first user-provided unstructured data through the user operation interface 21. For example, as shown in FIGS. 3A and 3B, after the user clicks the “Expert Dialogue” button on the user operation interface 21, the central display section 212 is updated to present multiple entry icons for domain-specific AI agents, including “Parameter Design Copilot,” “Industry Standards,” “Machine Operation,” “Machine Troubleshooting,” and “Customer Complaint and Anomaly Reporting.” Each interactive button corresponds to a different domain-oriented task logic module 1223.

For example, after the user clicks the “Parameter Design Copilot” button, the system activates the corresponding domain-oriented task logic module 1223. The user may then input at least one first user-provided natural language content and/or upload at least one first user-provided unstructured data through the user operation interface 21. Correspondingly, the processor 121 first activates the SEV generation module 1222 to convert the first user-provided natural language content and/or the first user-provided unstructured data into a first semantic embedding vector, and then activates the large language model module 1224 to perform semantic recognition and intent parsing on the first semantic embedding vector, thereby obtaining at least one first task objective. Subsequently, the processor 121 activates the domain-oriented task logic module 1223 corresponding to the “Customer Complaint and Anomaly Reporting” AI agent, such that each of the domain-oriented task logic modules 1223 performs a first domain-oriented decision generation operation. The first domain-oriented decision generation operation includes:
based on the first semantic embedding vector, retrieving from the data warehouse 111 at least one of the reference vector data; and
based on the first task objective and the retrieved at least one reference vector data, generating a first retrieval-augmented data and transmitting the same to the large language model module 1224.

Next, the processor 121 activates the large language model module 1224 to generate, based on the first retrieval-augmented data, a first natural language specification and/or a first visualization specification, and transmits a user interface update data comprising the first natural language specification and/or the first visualization specification to the client-end electronic device 2, such that the user operation interface displays the first natural language specification and/or the first visualization specification. The first visualization specification includes at least one type selected from the group consisting of a table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

In practical applications, the client-end electronic device 2 may be, but is not limited to, a desktop computer, a laptop computer, a tablet computer, an all-in-one computer, or a smartphone. In certain usage scenarios, the user may directly click “Smart Dialogue.” In this case, the system determines that the user operation interface 21 has not been operated to select a specific one of the domain-oriented task logic modules 1223. Accordingly, the processor 121 activates the large language model module 1224 to perform semantic recognition and intent parsing on the first semantic embedding vector, and based on the results of the semantic recognition and intent parsing, selects at least one corresponding domain-oriented task logic module 1223 to perform the first domain-oriented decision generation operation.

It is worth further explaining that the semantic embedding vector generation module 1222 is designed and configured by computer science engineers (CS engineers) as a functional program module installed within the storage device 122. For example, the CS engineers may implement the module using development frameworks that support machine learning inference, such as Python or Node.js. During implementation, the CS engineers may adopt existing open-source or commercial embedding models, including but not limited to Sentence-BERT, OpenAI Embedding API, or other equivalent algorithms capable of converting natural language and unstructured data into high-dimensional semantic vectors. More specifically, when configuring the semantic embedding vector generation module 1222, the CS engineers establish a preprocessing submodule and a tokenization and semantic encoding submodule. The preprocessing submodule performs text normalization and unstructured data transformation, for instance, converting uploaded PDF, image, or document files into text sequences through optical character recognition (OCR) or text extraction pipelines. Subsequently, the semantic encoding submodule invokes the selected embedding model (e.g., Sentence-BERT or OpenAI Embedding API) to transform the processed content into semantic embedding vectors that represent the contextual meaning of the input. After verification and testing, the CS engineers package (deploy) the embedding model and related configuration files into the storage device 122, enabling the processor 121 to dynamically load and execute the semantic embedding vector generation module 1222 during system operation. Such design ensures that all subsequent domain-oriented task logic modules 1223 can access unified semantic vector representations, thereby supporting the retrieval and reasoning processes performed by the large language model module 1224.

In brief, in the artificial intelligence decision support system 1 of the present invention, the domain-oriented task logic module 1223 (also referred to as an LLM-based AI agent) serves as an intermediary layer bridging the large language model module 1224 and the data warehouse 111, and is configured to perform task-oriented retrieval and generation augmentation (RAG) operations for various expert domains. More specifically, each domain-oriented task logic module 1223 is implemented as an independent AI agent corresponding to a specific expert field, such as process parameter design, quality analysis, machine operation, equipment troubleshooting, or customer complaint and anomaly reporting. Each AI agent performs RAG operations based on a semantic embedding vector and a task objective, and assembles the obtained RAG data into corresponding prompt data to be provided to the large language model module 1224. Consequently, the large language model module 1224 can generate and present corresponding responses or solutions to the user through the user operation interface 21.

In practical implementation, each domain-oriented task logic module 1223 is programmed by computer science engineers (CS engineers) using a modular software framework, which may be developed in Python, Node.js, or other programming languages supporting large language model applications. Each module comprises a corresponding retrieval strategy submodule, a semantic vector matching submodule, and a prompt template submodule, and can perform data query and semantic retrieval from the data warehouse 111 via a built-in application programming interface (API), namely the aforementioned second application programming interface. To ensure the accuracy and traceability of the generated results, the CS engineers may construct a domain-specific dataset based on real manufacturing records and quality data, and train the task logic of each module through fine-tuning or prompt engineering methods. After training, each module is deployed within the storage device 122 and cooperates with the large language model module 1224, wherein the large language model module 1224 is responsible for semantic recognition and response generation, while each domain-oriented task logic module 1223 is responsible for retrieval, analysis, and decision generation. Through this collaborative architecture, the overall system can provide knowledge-grounded and verifiable responses to domain-specific decision-making problems.

It should be further explained that the aforementioned Retrieval-Augmented Generation (RAG) refers to a process in which, after receiving a semantic embedding vector and a task objective, the domain-oriented task logic module 1223 performs a vector similarity search within the data warehouse 111 to obtain at least one reference vector data associated with the semantic embedding vector. The retrieved results are then organized into a structured knowledge context, which is integrated with the task objective to generate retrieval-augmented data (RAG data). The RAG data serves as a prompt input for the large language model module 1224, thereby assisting in generating natural language responses or visualized outputs that are consistent with the enterprise knowledge base and verifiable in traceability. Accordingly, the RAG technique can be employed to improve the response quality of a generative AI system (i.e., the LLM module 1224) to a user-provided prompt (i.e., the aforementioned natural language content), beyond the performance achievable by the large language model alone.

As shown in FIG. 1, the first database 131 is deployed on a first electronic device 13, and the second database 141 is deployed on a second electronic device 14. Both the first electronic device 13 and the second electronic device 14 may be, but are not limited to, industrial-grade local storage devices, cloud storage devices, or data centers. More specifically, the first electronic device 13 is communicatively connected to the electronic device 11 and the host device 12, and the first database 131 stores a plurality of first structured data. On the other hand, the second electronic device 14 is communicatively connected to the electronic device 11, and the second database 141 stores a plurality of second structured data. It is readily understood that the first structured data correspond to internal company data of the specific user (e.g., a textile factory), while the second structured data correspond to external company data of the same specific user.

Further, the first semantic embedding vector includes a first vector portion associated with the first user-provided natural language content and a second vector portion associated with the user-provided unstructured data. The processor 121 is configured to activate the database management module 1225 to update the plurality of first structured data based on the second vector portion. In addition, the database management module 1225 is further used to update the plurality of reference vector data in the data warehouse 111 via the first application program interface (API) 112 according to the updated plurality of first structured data. Moreover, after the plurality of second structured data are updated, the database management module 1225 updates the plurality of reference vector data in the data warehouse 111 according to the updated plurality of second structured data.

As shown in FIGS. 1, 2, and 3A, after the user operation interface 21 is operated to perform a user account management action (for example, by clicking the personnel icon in the upper-right corner), the processor 121 activates the user account management module 1226 to process the data generated from the account management action and stores at least one account data generated therefrom in an account database. The account database stores at least one administrator account data corresponding to at least one administrator account, and a plurality of regular account data respectively corresponding to a plurality of regular accounts.

Depending on different application scenarios, the account management action may be a regular account management action or an administrator account management action. The regular account management action may include registering a regular account, logging into a regular account, logging out of a regular account, modifying regular account data, or deleting a regular account. Conversely, the administrator account management action may include registering an administrator account, logging into an administrator account, logging out of an administrator account, modifying administrator account data, creating a user group consisting of regular accounts, assigning access permissions to regular accounts, reviewing operation logs, or disabling regular accounts.

It is readily understood that after a regular account or an administrator account logs into the system, the processor 121 is configured to control the activation or deactivation of the plurality of domain-oriented task logic modules 1223 according to the permission level of the respective account. More specifically, when performing a regular account management action to log into a regular account, the processor 121 activates at least one corresponding domain-oriented task logic module 1223 according to the permission level of the regular account and deactivates the remaining domain-oriented task logic modules 1223. Conversely, when performing an administrator account management action to log into an administrator account, the processor 121 activates all of the domain-oriented task logic modules 1223 according to the permission level of the administrator account.

Moreover, the artificial intelligence decision support system 1 of the present invention may also assist a specific user (e.g., a textile factory) in handling customer complaint-related issues. As shown in FIG. 1, a customer-end electronic device 3 can provide customer-provided natural language content and/or customer-provided unstructured data to the host device 12 through a data transmission channel. It is understood that the customer-provided unstructured data may include files such as image files, PDF files, or Word documents, while the customer-provided natural language content includes the complaint content. Depending on different application environments, the data transmission channel may be, but is not limited to, a customer service application, an instant messaging application, a corporate web platform, or an e-mail transmission system. Accordingly, as shown in FIG. 1, the customer-end electronic device 3 transmits related data to the host device 12 through a gateway 4. Similarly, the client-end electronic device 2 also transmits related data to the host device 12 through the same gateway 4.

After receiving the customer-provided natural language content and/or customer-provided unstructured data, the specific user may select one of the following response modes: auto-response, human-in-the-loop semi-automatic response, or manual response. Specifically, in the manual response scenario, as shown in FIGS. 1, 2, and 3A, the user may click the “Customer Complaint and Anomaly Reporting” domain-specific AI agent under the “Expert Dialogue” section, and then input in the chat window a second user-provided natural language content corresponding to the customer-provided natural language content and/or upload the at least one customer-provided unstructured data. Subsequently, the SEV generation module 1222 converts the second user-provided natural language content and/or the customer-provided unstructured data into a second semantic embedding vector, and the large language model module 1224 performs semantic recognition and intent parsing on the second semantic embedding vector to obtain at least one second task objective. Then, the domain-oriented task logic module 1223 corresponding to the “Customer Complaint and Anomaly Reporting” agent executes a second domain-oriented decision generation operation, which includes the following steps:
based on the second semantic embedding vector, retrieving from the data warehouse 111 at least one of the reference vector data; and
based on the second task objective and the retrieved at least one reference vector data, generating a second retrieval-augmented data and transmitting the same to the large language model module 1224.

Consequently, the large language model module 1224 generates a second natural language specification and/or a second visualization specification based on the second retrieval-augmented data, and transmits second user interface update data containing the second natural language specification and/or the second visualization specification to the client-end electronic device 2, such that the user operation interface 21 displays the corresponding natural language specification and/or visualization specification. The second visualization specification may include, but is not limited to, a table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, or dashboard view.

Of course, after reviewing the second natural language specification and/or the second visualization specification, the user may operate the client-end electronic device 2 to transmit feedback response data containing the second natural language specification and/or the second visualization specification to the customer-end electronic device 3, thereby completing the response to the customer complaint issue.

In addition, in the human-in-the-loop (semi-automatic response) mode, the host device 12 is configured to directly receive the customer-provided natural language content and/or customer-provided unstructured data from the customer-end electronic device 3, and then generate a second semantic embedding vector for the large language model module 1224 to perform semantic recognition and intent parsing. After invoking the domain-oriented task logic module 1223 corresponding to the “Customer Complaint and Anomaly Reporting” agent to perform the second domain-oriented decision generation operation, the large language model module 1224 generates a second natural language specification and/or a second visualization specification based on the generated second retrieval-augmented data, and transmits second user interface update data containing the same to the client-end electronic device 2, such that the user operation interface 21 displays the natural language specification and/or visualization specification. Subsequently, after reviewing the second natural language specification and/or the second visualization specification, the user operates the client-end electronic device 2 to transmit feedback response data containing the second natural language specification and/or the second visualization specification to the customer-end electronic device 3, thereby completing the response to the customer complaint issue.

On the other hand, in the auto-response mode, the host device 12 is configured to automatically perform semantic embedding vector generation, semantic recognition and intent parsing, and domain-oriented decision generation operations upon receiving the customer-provided natural language content and/or the customer-provided unstructured data, thereby generating the corresponding retrieval-augmented data. Subsequently, the large language model module 1224 automatically generates a final natural language reply and/or a visualization specification based on the retrieval-augmented data, and directly transmits reply result data containing the reply content to the customer-end electronic device 3, thereby completing the reply process automatically without human intervention.

In other words, the second semantic embedding vector includes a third vector portion associated with the customer-provided natural language content and a fourth vector portion associated with the customer-provided unstructured data. That is, during the process in which the customer complaint data enters the system, the SEV generation module 1222 not only converts the textual description into the semantically interpretable third vector portion, but also generates the corresponding fourth vector portion for additional unstructured data such as documents, reports, images, or audio files. In this way, the overall embedding vector can simultaneously reflect the semantic relevance between the complaint content and the associated evidential materials. Subsequently, the database management module 1225 automatically structures the complaint data based on the fourth vector portion and updates it to the specific user's internal database (i.e., the first database 131). This step allows previously unstructured complaint materials (e.g., inspection reports or image attachments) to be converted into structured data that can be utilized by subsequent analytical modules, thereby supporting decision traceability and problem analysis. Furthermore, once the structured data in the first database 131 is updated, the database management module 1225 performs synchronous updating through the first application program interface (API) 112, such that the plurality of reference vector data stored in the data warehouse 111 can be re-indexed and reweighted according to the updated content. This design ensures that the data warehouse 111, when executing retrieval-augmented generation (RAG) in subsequent operations, can accurately reflect the most recent customer complaint and response information, thereby preventing outdated or inconsistent retrieval results during semantic search processes.

Therefore, through the above descriptions, all embodiments of the artificial intelligence decision support system according to the present invention have been introduced completely and clearly. Moreover, the above description is made on embodiments of the present invention. However, the embodiments are not intended to limit the scope of the present invention, and all equivalent implementations or alterations within the spirit of the present invention still fall within the scope of the present invention.

What is claimed is:

1. An artificial intelligence decision support system, being implemented in the form of a computer system, and comprising:
at least one electronic device, comprising a data warehouse, wherein the data warehouse stores a plurality of reference vector data associated with a plurality of structured reference data;
at least one host device, being communicatively connected to the electronic device for accessing the data warehouse, and including a processor and a storage device, wherein the storage device stores an application program comprising a semantic embedding vector generation module, a plurality of domain-oriented task logic modules, and a large language model (LLM) module, and wherein the processor executes the application program and is thereby configured to perform the following operations:
under a condition where a client-end electronic device is communicatively connected to the host device, transmitting a user interface configuration data to the client-end electronic device, such that the client-end electronic device controls a corresponding client-end display to show a user operation interface;
upon the user operation interface being operated to input at least one first user-provided natural language content and/or upload at least one first user-provided unstructured data, activating the semantic embedding vector generation module to convert the first user-provided natural language content and/or the first user-provided unstructured data into a first semantic embedding vector;
activating the large language model module to perform semantic recognition and intent parsing on the first semantic embedding vector, thereby obtaining at least one first task objective;
activating at least one of the domain-oriented task logic modules corresponding to the at least one first task objective, such that each of the domain-oriented task logic modules performs a first domain-oriented decision generation operation, wherein the first domain-oriented decision generation operation includes:
based on the first semantic embedding vector, retrieving from the data warehouse at least one reference vector data that includes at least one of the structured reference data; and
based on the first task objective and the retrieved at least one reference vector data that includes at least one of the structured reference data, generating a first retrieval-augmented data and transmitting the same to the large language model module;
activating the large language model module to generate, based on the first retrieval-augmented data, a first natural language specification and/or a first visualization specification; and
transmitting a user interface update data comprising the first natural language specification and/or the first visualization specification to the client-end electronic device, such that the user operation interface displays the first natural language specification and/or the first visualization specification;
wherein the first visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

2. The artificial intelligence decision support system according to claim 1, wherein processor is further configured to perform the following operations:
upon the client-end electronic device receiving from a customer-end electronic device at least one customer-provided natural language content and/or at least one customer-provided unstructured data, and upon the user operation interface being operated to input at least one second user-provided natural language content and/or upload the at least one customer-provided unstructured data, activating the semantic embedding vector generation module to convert the second user-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
based on the second semantic embedding vector, retrieving from the data warehouse at least one reference vector data; and
based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting second user interface update data comprising the second natural language specification and/or the second visualization specification to the client-end electronic device, such that the user operation interface displays the second natural language specification and/or the second visualization specification;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

3. The artificial intelligence decision support system according to claim 1, wherein the processor is further configured to perform the following operations:
after receiving from a customer-end electronic device at least one customer-provided natural language content and/or uploading at least one customer-provided unstructured data, activating the semantic embedding vector generation module to convert the customer-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
based on the second semantic embedding vector, retrieving from the data warehouse at least one reference vector data; and
based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting a reply feedback data comprising the second natural language specification and/or the second visualization specification to the client-end electronic device, such that the client-end electronic device forwards the reply feedback data to the customer-end electronic device;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

4. The artificial intelligence decision support system according to claim 1, wherein the processor is further configured to perform the following operations:
receiving from a customer-end electronic device at least one customer-provided natural language content and/or uploading at least one customer-provided unstructured data, activating the semantic embedding vector generation module to convert the customer-provided natural language content and/or the customer-provided unstructured data into a second semantic embedding vector;
activating the large language model module to perform semantic recognition and intent parsing on the second semantic embedding vector, thereby obtaining at least one second task objective;
activating at least one of the domain-oriented task logic modules corresponding to the at least one second task objective, such that each of the domain-oriented task logic modules performs a second domain-oriented decision generation operation, wherein the second domain-oriented decision generation operation includes:
based on the second semantic embedding vector, retrieving from the data warehouse at least one reference vector data; and
based on the second task objective and the retrieved at least one reference vector data, generating a second retrieval-augmented data and transmitting the same to the large language model module;
activating the large language model module to generate, based on the second retrieval-augmented data, a second natural language specification and/or a second visualization specification; and
transmitting a reply feedback data comprising the second natural language specification and/or the second visualization specification to the customer-end electronic device;
wherein the second visualization specification includes at least one type selected from a group consisting of table, bar chart, column chart, line chart, area chart, scatter chart, pie chart, curve chart, doughnut chart, radar chart, trend chart, distribution plot, bubble chart, stock chart, flow diagram, relation diagram, waterfall chart, histogram, box & whisker chart, pivot chart, and dashboard view.

5. The artificial intelligence decision support system according to claim 2, wherein he customer-end electronic device is configured to provide the customer-provided natural language content and/or the customer-provided unstructured data to the host device through a data transmission channel, wherein the data transmission channel is selected from a group consisting of customer service application, instant messaging application, corporate web platform, and email transmission system.

6. The artificial intelligence decision support system according to claim 2, wherein each of the client-end electronic device and the customer-end electronic device is selected from a group consisting of desktop computer, laptop computer, tablet computer, all-in-one computer, and smartphone.

7. The artificial intelligence decision support system according to claim 2, wherein the electronic device is selected from a group consisting of local storage device, cloud storage device, and data center, and further includes a first application program interface (API).

8. The artificial intelligence decision support system according to claim 1, wherein the host device is selected from a group consisting of AI computing platform, server, cloud computing device, and edge computing device.

9. The artificial intelligence decision support system according to claim 1, wherein the storage device is selected from the group consisting of a hard disk drive (HDD), a flash memory, and a solid-state drive (SSD).

10. The artificial intelligence decision support system according to claim 1, wherein the file format of the unstructured data is selected from a group consisting of document file, report file, portable document format (PDF) file, text file, E-mail data file, image file, audio file, video file, event log file, event data file, sensor log file, and configuration file.

11. The artificial intelligence decision support system according to claim 7, wherein application program further comprises:
a user interface configuration module; and
a database management module;
wherein, when executing the application program, the processor activates the user interface configuration module to generate the user interface configuration data, and activates the database management module to manage the data warehouse.

12. The artificial intelligence decision support system according to claim 11, further comprising:
at least one first electronic device, being communicatively connected to the electronic device and the host device, and including a first database that stores a plurality of first structured data; and
at least one second electronic device, being communicatively connected to the electronic device, and including a second database that stores a plurality of second structured data;
wherein each of the first structured data corresponds to and internal company data, and each of the second structured data corresponds to an external company data;
wherein the first semantic embedding vector includes a first vector portion associated with the first user-provided natural language content and a second vector portion associated with the user-provided unstructured data, and the database management module updates the plurality of first structured data based on the second vector portion, and further configures the first application program interface (API) to update the plurality of structured reference data in the data warehouse according to the updated first structured data;
wherein the second semantic embedding vector includes a third vector portion associated with the customer-provided natural language content and a fourth vector portion associated with the customer-provided unstructured data, and the database management module updates the plurality of first structured data based on the fourth vector portion, and further configures the first application program interface (API) to update the plurality of structured reference data in the data warehouse according to the updated first structured data;
wherein, after the plurality of second structured data are updated, the database management module updates the plurality of structured reference data in the data warehouse according to the updated second structured data.

13. The artificial intelligence decision support system according to claim 12, wherein the application program further comprises a user account management module, and the processor is further configured to perform the following operations:
upon the user operation interface being operated to perform a user account management action, activating the user account management module to process data generated from the account management action, and to store at least one account data generated from the account management action into an account database, such that the account database stores at least one administrator account data corresponding to at least one administrator account, and a plurality of regular account data respectively corresponding to a plurality of regular accounts;
wherein the account management action is selected from a group consisting of regular account management actions and administrator account management actions;
wherein the regular account management action is selected from a group consisting of registering one of the plurality of regular accounts, logging into the regular account, logging out of the regular account, modifying regular account data, and deleting the regular account;
wherein the administrator account management action is selected from a group consisting of registering the administrator account, logging into the administrator account, logging out of the administrator account, modifying administrator account data, creating a user group consisting of at least one of the plurality of regular accounts, assigning access permissions to at least one of the plurality of regular accounts, reviewing operation logs, and disabling at least one of the plurality of regular accounts.

14. The artificial intelligence decision support system according to claim 13, wherein the processor is further configured to perform the following operations:
controlling the activation or deactivation of the plurality of domain-oriented task logic modules according to the permission level of the regular account or the administrator account;
upon performing a regular account management action to log into the regular account, activating at least one of the domain-oriented task logic modules corresponding to the permission level of the regular account, and deactivating the remaining domain-oriented task logic modules; and
upon performing an administrator account management action to log into the administrator account, activating all of the domain-oriented task logic modules according to the permission level of the administrator account.

15. The artificial intelligence decision support system according to claim 14, wherein the processor is further configured to perform the following operations:
when the user operation interface is not operated to select a specific one of the domain-oriented task logic modules, activating the large language model module to perform semantic recognition and intent parsing on the first semantic embedding vector, and selecting, based on the results of the semantic recognition and intent parsing, at least one corresponding domain-oriented task logic module to perform the first domain-oriented decision generation operation; and
when the user operation interface is operated to select a specific one of the domain-oriented task logic modules, directly selecting the specified domain-oriented task logic module to perform the first domain-oriented decision generation operation.
